(19) United States
(12) Patent Application Publication
(10) Pub. No.: US 2005/0141888 A1
(43) Pub. Date: Jun. 30, 2005

(54) Heating device and heating method for a fluid in a basin

(75) Inventor: Karsten Laing, Althutte (DE)

Correspondence Address: FOLEY & LARDNER, P.O. BOX 80278, SAN DIEGO, CA, 92138-0278, US

(73) Assignee: Oliver Laing, Karsten Laing, Birger Laing

(21) Appl. No.: 10/768,843

(22) Filed: Jan. 29, 2004

(30) Foreign Application Priority Data
Jan. 30, 2003 (DE) 103 04 398.5-34
May 8, 2003 (DE) 103 22 366.5-34

(51) Int. Cl. H05B 3/60

(52) U.S. Cl. 392/322

(57) ABSTRACT

According to one embodiment of the invention, a heating device for a fluid in a basin includes a flow-through path for a fluid reservoir of the basin and a heater arranged in the flow-through path. The fluid is able to flow past the heater for the purpose of heating up. The device also includes at least one heating element arranged in the heater and a temperature sensor in thermal communication with the heater. The thermal communication is sufficient for the temperature sensor to determine a temperature of the heater. The temperature sensor is adapted to determine absolute temperatures and changes in temperatures based on the thermal communication.

### CROSS-REFERENCE TO RELATED PATENT APPLICATIONS

German Priority Application 103 04 398.5-34, filed Jan. 30, 2003, and German Priority Application 103 22 366.5, filed May 8, 2003, including the specifications, drawings, claims and abstracts, are incorporated herein by reference in their entirety. Further, U.S. patent application Ser. No. ______, Attorney Docket No. 027209-1101, filed concurrently herewith, is hereby incorporated by reference in its entirety.

### BACKGROUND OF THE INVENTION

The invention relates to heating devices. In particular, the invention relates to heating devices for a fluid in a basin, such as a whirlpool, spa or bath tub, for example.

### SUMMARY OF THE INVENTION

According to one embodiment of the invention, a heating device for a fluid in a basin includes a flow-through path for a fluid reservoir of the basin and a heater arranged in the flow-through path. The fluid is able to flow past the heater for the purpose of heating up. The device also includes at least one heating element arranged in the heater and a temperature sensor in thermal communication with the heater. The thermal communication is sufficient for the temperature sensor to determine a temperature of the heater. The temperature sensor is adapted to determine absolute temperatures and changes in temperatures based on the thermal communication.

The temperature sensor may be arranged in direct thermal contact with the heater. The temperature sensor may be arranged on an outer side of a tube forming at least a portion of the flow-through path.

A tube forming at least a portion of the flow-through path may have a contoured, flattened or recessed area. The temperature sensor may be arranged on an outer surface of the tube in that area. The contoured, flattened or recessed area may include a substantially flat surface. In a preferred embodiment, the heater is positioned on or near an inner wall of the tube substantially opposing the temperature sensor. A gap may be located between the heater and the inner wall of the tube in the flattened or recessed area, with the fluid being able to flow through the gap.

The at least one heating element is preferably an electrical resistor element having an extension in a longitudinal direction of the heater. The heating device may further include at least one thermal melting fuse adapted to interrupt an electrical circuit for the at least one heating element when a predetermined temperature is exceeded. The thermal melting fuse is preferably positioned in the vicinity of the temperature sensor.

The heating device may further include an evaluating device for evaluating signals of the temperature sensor. The evaluating device may be adapted to recognize whether a reduced volume throughput of fluid through the flow-through path is present based upon signals of the temperature sensor. Further, the evaluating device may be adapted to recognize whether a reversible case of malfunction or an irreversible case of malfunction is present when a reduced volume throughput is recognized. The evaluating device may be adapted to recognize whether any dry running of the heater is present based upon signals of the temperature sensor.

The heating device may include a circulation pump adapted to be switched off via the evaluating device. The circulation pump may be adapted to be switched off by the evaluating device when a minimum throughput is not reached. At least one of a signal line for controlling the switching off of the circulation pump and an electrical energy supply line may be guided through the heater.

In a preferred embodiment, the flow-through path is dimensioned to prevent any dry running of the heater in the case of a throughput of fluid above a minimum throughput.

### BRIEF DESCRIPTION OF THE DRAWINGS

FIG. 1 shows a plan view of a basin, on which a heating device according to an embodiment of the invention is mounted;

FIG. 2 shows a side view of the arrangement of FIG. 1 in the direction A;

FIG. 3 shows a plan view of a tube area of an embodiment of a heating device having a temperature sensor;

FIG. 4 shows a cross-sectional view of the tube according to FIG. 3 along line 4-4; and

FIG. 5 shows an exemplary course of the temperature over the time during dry running (steep curve) and with a blocked inlet or outlet (flatter curve).

### DETAILED DESCRIPTION OF CERTAIN EMBODIMENTS

The following description of preferred embodiments serves to explain the invention in greater detail in conjunction with the drawings.

In accordance with an embodiment of the present invention, a heating device is provided with which an improved switch-off control of the heating is ensured.

In accordance with an embodiment of the invention, a temperature sensor is provided which is arranged so as to be in thermal communication with respect to the heater such that a heating temperature of the heater may be determined and absolute temperatures and changes in the temperature may be determined via the temperature sensor.

In this regard, the phrase “absolute temperature” is used to refer to a temperature level on any given scale such as Fahrenheit, Celsius and Kelvin, for example. The accuracy of the measurement or determination of “absolute temperature” may vary according to various components and their calibration, for example.

When fluid flows in the flow-through path, stationary temperature conditions ensue in the case where no malfunctions occur; the heater heats the fluid and heat is carried away from the heater by the fluid flowing past the heater. If the amount of fluid is reduced or the flow even ceases, heat is carried away from the heating element of the heater only partially or even not at all, causing the region of the heating elements to heat up beyond nominal temperature. This heating up is detected by the temperature sensor. As a result of the arrangement of the temperature sensor, deviations from the stationary temperature conditions may be measured exactly and with short reaction times.

Malfunctions may then be recognized early in order to be able to, accordingly, also switch off the heating early. On account of short reaction times and high accuracy which is brought about by the thermal communication between the heater and the temperature sensor, malfunctions can also be evaluated in order, for example, to determine whether the case of malfunction is a critical one, requiring a permanent switching off of the heating, or whether it is a less critical malfunction which does not require a permanent switching off. A switch-off control may then be realized which, on the one hand, does not make any unnecessary intervention of an operator on account of less critical malfunctions necessary but, on the other hand, causes a permanent switching off of the heating of the heater with a short reaction time in the case of critical malfunctions. In the case of critical malfunctions, an operator has, for example, to see to it that the malfunction is eliminated whereas in the case of uncritical malfunctions intervention by an operator is not necessary.

As a result of the fact that, in accordance with embodiments of the invention, changes in temperature can also be determined in addition to absolute temperatures, it may be recognized whether an increase in temperature is attributable to dry running or to a reduced throughput of fluid through the flow-through path. It may be recognized early, in particular, whether the transport of fluid through the flow-through path is interrupted. The heating can then be switched off immediately and dry running thereby prevented. In addition, it may also be recognized whether any dry running is present in order to achieve additional safety.

In accordance with embodiments of the invention, an “intelligent” monitoring of dry running may be realized, with which less critical cases of malfunction can be recognized.

The temperature sensor is advantageously in direct thermal contact with the heater. As will be explained below, a small gap may be formed between the heater and a heat-conducting element, to which the temperature sensor is thermally coupled, so that the heater and the heat-conducting element do not touch directly. In this respect, the gap may be sized such that the transfer of heat is still sufficient for the temperature sensor to recognize the temperature of the heater early enough to avoid damage in the case of any dry running.

In one advantageous embodiment, the temperature sensor is arranged on an outer side of a tube or pipe which forms the flow-through path. The temperature sensor may then be positioned on the tube in a simple manner. Lines which connect the temperature sensor to an evaluating device may be guided in a simple manner. The production resources required can be minimized as a result.

It is particularly advantageous when a tube which forms the flow-through path has a contoured, flattened or recessed (e.g., deepened) area, on which the temperature sensor is arranged. The temperature sensor may be arranged closer to the heater as a result of such a recessed area, thereby improving thermal contact. As a result, the temperature of the heater may be determined with short delay times. In addition, it is possible to be able to evaluate increases in temperature more precisely. Such a contoured, flattened or recessed area may be produced on the tube in a simple manner.

Furthermore, it is favorable when the contoured, flattened or recessed area has an essentially flat surface. A good thermal contacting between the temperature sensor and the tube may be achieved in the recessed area, and a good thermal contact can be provided.

With respect to a distance between a longitudinal axis of the heater and a limiting wall of the tube, the heater can be seated on the contoured, flattened or recessed area, or in direct vicinity of the contoured, flattened or recessed area. As a result, the distance between the limiting wall and the heater may be minimized in order to provide a good thermal contact.

It may be possible for the heater to touch the limiting wall of the tube on an inner side of the tube. It may also be provided for a gap, through which fluid can flow, to be located between the heater and an inner wall of the tube in the contoured, flattened or recessed area. This gap may be sized such that the transfer of heat does not significantly deteriorate. A typical magnitude for the size of the gap (e.g., transversely to a longitudinal axis of the tube) is in the range of about 0.1 mm. As a result of a gap being provided, an improved differentiation between dry running and reduced throughput can be achieved. The gap makes a space available between the heater and the inner wall of the tube. When the gap has fluid flowing through it, a good transfer of heat is present. Without any fluid located in the gap (e.g., “air filling” of the gap), it has the effect of a thermal insulator, and the transfer of heat deteriorates. The gap, therefore, serves a discriminator function which causes a differentiatable change in signal in the case of any dry running.

The at least one heating element is favorably an electrical resistor element which has an extension in a longitudinal direction of the heater. As a result of such a heating element, an effective heating up of the fluid flowing past the heater can be achieved. A corresponding heating element may be embedded in the heater in an effective manner.

It is favorable when at least one thermal melting fuse is provided, via which the electrical circuit for the at least one heating element can be interrupted when a critical temperature is exceeded. In this respect, an emergency switching off is achieved irrespective of any measurement of the temperature. If, for example, the temperature sensor fails, a “hardware switching off” of the heating can be carried out when the critical temperature is exceeded.

In this respect, the at least one thermal melting fuse is preferably arranged in the vicinity of the temperature sensor. For example, the thermal melting fuse can be arranged on a contoured, flattened or recessed area, on which the temperature sensor is likewise arranged. A small distance to the heater is predetermined by the flattened or recessed area, and any increase in temperature and, in particular, any exceeding of the critical temperature has an effect on the melting fuse with little delay.

It is particularly advantageous when an evaluating device is provided which evaluates the signals of the temperature sensor. A temperature surveillance device, which has a certain intelligence, may be formed via this evaluating device. Malfunctions may be recognized which are reversible and require only a temporary, limited switching off of the heating. However, critical cases of malfunction, such as, for example, any dry running, which make a permanent switching off of the heating necessary, may also be recognized.

In this respect, it may be recognizable, due to the evaluating device by means of the signals of the temperature sensor, whether a reduced volume throughput of fluid through the flow-through path is present and whether the volume throughput is interrupted. A reduced volume throughput can be attributable to an interruption in the transport by the pump or to a blockage of an exit point at a basin which is connected to an entry point of the flow-through path. When a reduced volume throughput and, in particular, a zero transport is recognized, the heating is switched off. It can be differentiated via the increase in temperature (e.g., ascending gradient) whether a sudden reduction in throughput is involved, which may be rectified when the heating is switched on again following a waiting period, or whether a gradual increase in temperature is present, which may require special intervention. A sudden reduction in throughput can occur when a person has positioned himself in the tub in front of a fluid outlet and is blocking it, for example. A gradual reduction in throughput is attributable, for example, to soiling of the filter.

Additionally, it may be recognizable, due to the evaluating device by means of the signals of the temperature sensor, whether any dry running of the heater is present. This may be recognized, for example, from the increase in temperature. A steep rise in the temperature may point to dry running, whereas a flatter rise in the temperature may be attributable to a reduced volume throughput.

It is particularly favorable when reversible and irreversible malfunctions can be recognized by means of the evaluating device, in particular, via the type of increase in the temperature.

Furthermore, in a preferred embodiment, a circulation pump can be switched off via the evaluating device. The circulation pump may be switched off by the evaluating device, for example, when a minimum throughput is not reached. As a result, the circulation pump is prevented from being operated when no fluid throughput takes place. Damage to the circulation pump, which can be caused by a zero throughput or by dry running, can be avoided in this way.

A compact heating device may be constructed when a signal line for controlling the switching off of the circulation pump or an electrical energy supply line to the circulation pump is guided through the heater. The circulation pump may then be switched off by means of the evaluating device, in that a switch-off signal may be supplied to the pump or the energy supply is interrupted, for example, via a relay.

It is particularly advantageous when a free cross-section of the flow-through path is dimensioned such that any dry running of the heater in the case of a throughput of fluid above a minimum throughput is prevented. A flow channel of the flow-through path is correspondingly narrow in order to prevent any dry running. Thus, dry running can only result when the throughput is below the minimum throughput and, for example, when a zero throughput is present. It may, however, be monitored via the evaluation of the increase in temperature whether a minimum throughput is reached. Dry running may, therefore, be prevented by an early switching off. It is possible, as a result of the corresponding dimensioning of the flow-through path, to arrange the temperature sensor along the flow-through path at any practical position. It need not necessarily be arranged at a highest point in relation to the direction of gravity.

The embodiments of the invention relate, in addition, to a heating method for a fluid in a basin, with which the fluid from the basin runs through a heating path which may be located outside a reservoir of the basin and is heated by a heater, with at least one heating element arranged in the heater.

Also, in accordance with embodiments of the invention, a heating method is provided that can be carried out in a simple and reliable manner.

This can be accomplished in that the temperature of the heater is monitored via a temperature sensor which can determine absolute temperatures and temporal changes in the temperature at the heater.

The advantages of the inventive heating method have already been explained in conjunction with the inventive heating device.

Additional advantageous developments of embodiments of the inventive method have likewise already been explained in conjunction with the inventive heating device.

It can be, for example, determined via registration of a temperature course in time whether the fluid throughput through the heating path or loop is below a minimum throughput and, in particular, whether a zero throughput is present. The heating can then be switched off before the risk of any dry running occurs.

Furthermore, it may be provided for a circulation pump to be switched off when a minimum throughput is not reached and, in particular, at a zero throughput in order to avoid any damage to the pump.

Embodiments of the invention relate to a heating device for a fluid in a basin, comprising a flow-through path which can be positioned outside a fluid reservoir of the basin, a heater which is arranged in the flow-through path and has the fluid flowing past it for the purpose of heating up, and at least one heating element which is arranged in the heater. Such a heating device, which is used, in particular, for a whirlpool (spa) or a bath tub, is known, for example, under the name Laing Infinity Heater.

The heating is based on the principle of continuous flow heating, i.e., fluid is coupled out of the basin and heated up when passing through the flow-through path. Heated fluid is then coupled into the basin again. In this respect, the basic problem is that malfunctions can occur which lead to dry running of the flow-through path or loop. A reduced amount of fluid then flows in the flow-through path or no fluid at all flows through it. In such cases, it is necessary to switch the heating off.

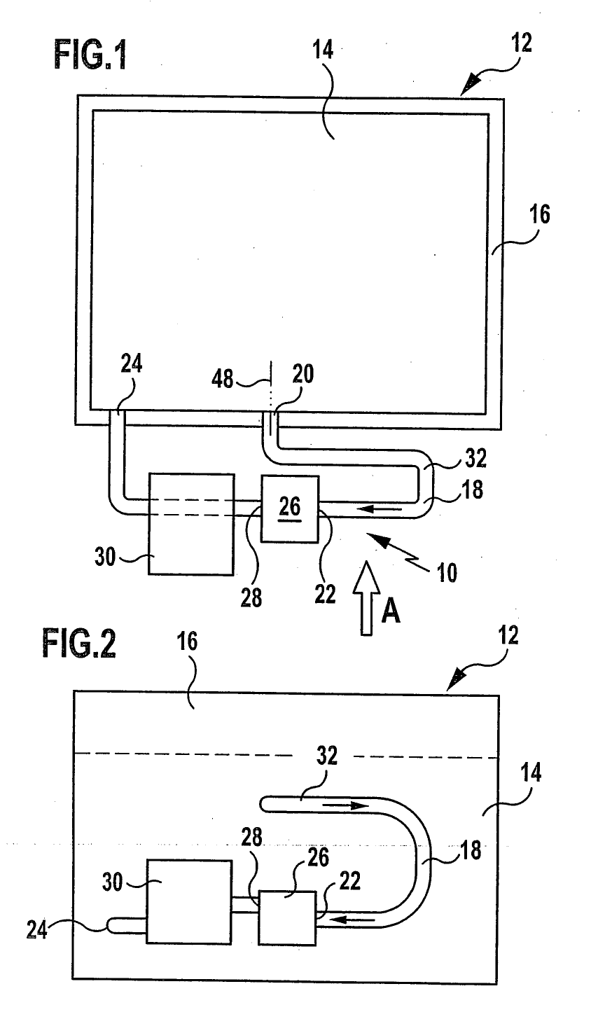

Referring now to the Figures, an inventive heating device, of which one embodiment is shown in FIG. 1 and designated as a whole as 10, is used for heating or maintaining a temperature of a fluid in a basin 12. The basin 12 has a reservoir 14 for the fluid which is contained within basin walls 16.

The basin 12 with fluid accommodated in the reservoir 14 may be a whirlpool or a bath tub, for example, with water to be heated.

In the illustrated embodiment, the heating device 10 is arranged outside the reservoir 14 and positioned, for example, on an outer side of the basin wall 16 or positioned on a corresponding holding frame with respect to the basin 12. The heating device 10 comprises a flow-through path 18 which is arranged outside the reservoir 14 and which comprises a heating path, in which the fluid can be heated up.

The flow-through path 18 has an entry end 20, via which fluid from the reservoir 14 can enter the flow-through path 18. For this purpose, the basin wall 16 may be provided with a continuous recess and may have an opening so that fluid from the reservoir 14 can be guided through the heating device 10.

Furthermore, the flow-through path 18 has an exit end 22 which is in effective fluid communication with an entry point 24 for fluid heated up by the heating device 10 into the reservoir 14. The exit end 22 may be coupled directly to the entry point 24 in a fluid-effective manner. It may also be provided, as shown in FIG. 1, for the exit end 22 of the flow-through path 18 to be coupled to an entry to a circulation pump 26, wherein an exit 28 of the circulation pump 26 is then coupled to the entry point 24 into the reservoir 14 of the basin 12.

In the case of whirlpools, an ozone device 30 is generally provided which is connected in front of the entry point 24 for fluid into the reservoir 14 (with respect to the direction of flow of the fluid) and is arranged, for example, between the entry point 24 and the outlet 28 of the circulation pump 26. The fluid coupled into the reservoir 14 of the basin 12 can previously be disinfected by way of ozonization via the ozone device 30. The ozone device 30 may be connected behind the heating device 10 and its flow-through path 18.

In the case of bath tubs, no ozone device is generally provided, and the outlet 28 of the circulation pump 26 is coupled directly to the entry point 24 of the reservoir 14.

In the case of a heating device 10 positioned on the basin 12, the entry end 20 of the flow-through path 18 of the heating device 10 is generally, in the case of whirlpools, located above the exit end 22 of the flow-through path 18 with respect to the direction of gravity. As a result, fluid from the reservoir 14 is removed at a higher level than it is coupled into the reservoir 14 again.

In the case of bath tubs, the exit end of the flow-through path is generally at a higher level than the entry end (e.g., fluid to be heated is removed from the basin at the bottom and hot fluid flows into the basin above this).

The flow-through path 18 is formed in a tube 32 which can be bent in order to be able to position the heating device 10 on the basin 12 in an optimum manner.

The tube 32 has an extension in a longitudinal direction in order to form in this way the flow-through path 18 for the fluid coupled out of the reservoir 14. This extension is not necessarily linear.

A heater 33 with at least one heating element 34 (FIG. 4) is arranged in the tube 32 and, therefore, in the flow-through path and this heater extends along the tube 32, adapted to its shape and, for example, to the curvatures in it. The heating element 34 follows this course. The heating element 34 may be an electrical resistance heating element. The fluid flowing past the heater 33 may be heated via such a heating element 34 over a relatively long distance, wherein the specific power density per area can be kept small.

The heater 33 arranged in the tube (pipe) 32 is preferably designed as a heating rod 36. This heating rod 36 comprises a single or a plurality of recesses 38 which extend in its longitudinal direction and have, for example, a circular cross section. In the embodiment shown in FIG. 4, a single recess is provided. The heating element 34 is arranged in the recess 38.

The heating rod 36 has a metallic sleeve 40 which serves as a protective casing for an area 42 of solid material (FIG. 4). The recess 38 is formed in this area 42 of solid material. The material for the area 42 of solid material is preferably a solid-state material with a high heat conductivity which is electrically insulating. For example, magnesium oxide may be used as such a material.

The heating element 34 is surrounded by the solid material, wherein the heating element 34 touches the area of solid material in order to provide thermal contact. (In FIG. 4, the contact is not shown for reasons of illustration).

The heating rod 36 is securely arranged in the tube 32 and can be bent with the tube 32. For example, the heating rod 36 with the heating element 34 is securely positioned in the tube 32, and during the bending of the tube 32 into the desired position, the heating rod 36 is bent with it.

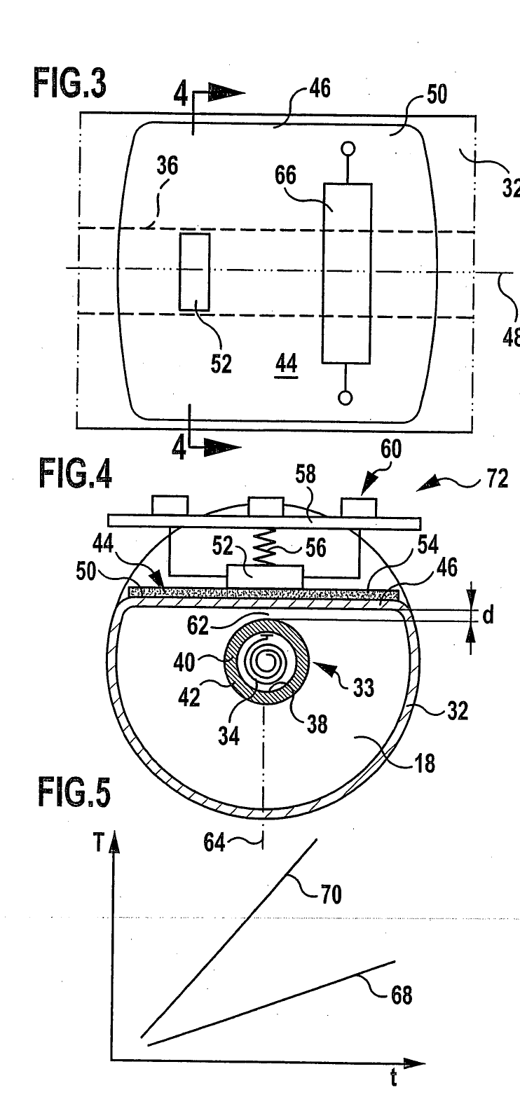

The tube 32 preferably has a generally circular outer cross section and a generally circular inner cross section. A contoured, flattened or recessed area 44 (FIGS. 3 and 4) may be provided, at which the distance between a limiting wall 46 of the tube 32 and the heater 33 transversely to the longitudinal direction of the heater is decreased. In the illustrated embodiment, this area 44 is generally flattened.

The flattened area 44 extends in the longitudinal direction 48 of the tube 32 in a finite area and, for example, not over the entire length of the tube 32.

The flattened area 44 has an outer side 50 which is generally flat. The corresponding plane of the flattened area 44 has a normal direction which is oriented transversely and at right angles to the longitudinal direction of the heater 33. A temperature sensor 52, which may be, for example, a semiconductor temperature sensor, is seated on this outer side 50. The temperature sensor 52 is arranged such that it is located at a minimal distance in relation to the heater 33. It may, for example, be arranged centrally on the flattened area 44 of the tube 32.

The temperature sensor 52 is in thermal contact with the limiting wall 46 of the flattened area 44. For example, a heat paste 54 or the like may be arranged between the temperature sensor 52 and the limiting wall 46 in order to provide for a good thermal contact with the heater 33.

In addition, the temperature sensor 52 may be pressed against the limiting wall 46 via a spring 56 in order to provide a good mechanical contact with the flatted area 44, which may be a precondition for a good thermal contact with the heater 33.

The spring 56 may be supported on a rear side of a plate 58 which bears electrical circuit elements for the temperature sensor 52. An evaluating device 60, for example, may be arranged on this plate 58.

In the illustrated embodiment, the limiting wall 46 is in thermal contact with the heater 33. In this respect, it may be provided for the heater 33 to touch an inner side of the limiting wall 46 and so a direct thermal contact may be provided.

In the embodiment shown in FIG. 4, the heater 33 is positioned a short distance d from the inner side of the limiting wall 46. Thus, a gap 62 is formed, through which fluid can flow. The gap 62 has a sufficiently small extension with respect to the distance between the limiting wall 46 and the heater 33 such that a good transfer of heat from the heater 33 to the limiting wall 46 is brought about by the gap 62 with fluid located therebetween. A typical magnitude for the extension of this gap 62 in a transverse direction 64 at right angles to the longitudinal direction of the tube 32 is about 0.1 mm.

In addition, one or more thermal melting fuses 66 (FIG. 3) can be arranged in the flattened area 44. In a preferred embodiment, the melting fuse 66 is located in the vicinity of the temperature sensor 52. The melting fuse 66 is connected to the thermal heating element 34 and may be, for example, pressed against it. When a critical temperature is exceeded, corresponding lines of the melting fuse 66 melt, and the circuit formed via the heating element 34 is interrupted. As a result, the heating of the heating element 34 is also interrupted since electrical current no longer flows through it.

The functioning of the illustrated heating device will now be described.

When fluid flows around the heater 33, the fluid absorbs heat and conducts heat away from the heater 33. If the fluid throughput is reduced or a partial or complete dry running of the heater 33 is present, the heater 33 can discharge heat only to a reduced extent or can no longer discharge any heat, thereby causing its temperature to rise.

As a result of the arrangement of the temperature sensor 52 with a reduced distance in relation to the heater 33 and the presence of thermal contact between the heater 33 and the temperature sensor 52, an increase in the temperature may be detected exactly via the temperature sensor 52 with a minimal delay.

In this respect, absolute temperatures can be determined via the temperature sensor 52 through temporal changes in the temperature. The cause of the change in temperature may be concluded from the changes in temperature, for example, via the size of a temporal increase, as illustrated in FIG. 5.

A reduction in the throughput, for example, due to a blockage of the circulation pump 26 may lead to a temporary, slow increase in the temperature, as indicated by the temperature curve 68. In the case of any dry running of the flow-through path 18, steam can result, or air can enter. The temperature curve then may be very much steeper over time, as indicated by the temperature curve with the reference numeral 70 in FIG. 5. The evaluating device 60 can now recognize, for example, from the gradient of the temperature curve whether any dry running is present which makes an immediate, permanent switching off necessary because a malfunction which is considered not to be reversible has occurred, such as, for example, dry running with formation of steam.

If a reduction in throughput is ascertained, for example, via an increase in the temperature which exceeds a certain limit, indicating a reduction in throughput below a minimum throughput limit, the heating is likewise switched off. Signals may be transmitted to a primary control device or regulating device (not shown) for the basin 12 in order to initiate corresponding correction procedures. Alternatively, these correction procedures may be initiated directly. For example, the heating may be switched on again after a certain time without any external operator intervention being necessary in the case of malfunctions which are considered to be reversible.

If a reduced throughput and, in particular, a throughput under a minimum limit, is detected which is, for example, to a zero conveyance of the circulation pump 26, to blocked filters or to a blocked entry point 24, the heating may be switched off. Thus, dry running of the heater 33 can be avoided. In addition, it can also provided for the evaluating device 60 to deliver a switch-off signal to the circulation pump 26 in order to prevent any running of the pump with a lack of conveyance and, therefore, minimize the risk of damage to the circulation pump 26.

In this respect, a signal line may be guided from the evaluating device 60 through the heater 33 to the circulation pump 26. The evaluating device 60 generates a corresponding switch-off signal which can be transmitted through this line to the circulation pump 26. Alternatively, it may be provided for an energy supply line for the circulation pump 26 to be guided through the heater 33, wherein the supply of energy can be interrupted for switching off the circulation pump 26 by means of the evaluating device 60. For example, a relay may be arranged on the plate 58 for this purpose, and the energy supply line may be coupled to the relay.

Such a reduced throughput may be recognized due to the disclosed arrangement of the temperature sensor 52 and due to the ability to recognize increases in temperature—qualitative and quantitative.

The gap 62 also contributes to this. When fluid is flowing in the gap 62, a considerable transfer of heat to the limiting wall 46 is present, in contrast to the case when air is located in the gap 62. As a result, a greater differentiation between the cases of reduced throughput and dry running is achieved, thereby increasing the accuracy of evaluation.

In one embodiment, the flow-through path 18 is designed with respect to a free flow cross section to have a sufficiently narrow flow channel that dry running results only when the transport of fluid through the flow-through path 18 is interrupted. Thus, dry running results from interruption of the transport of fluid in the flow-through path 18. In accordance with embodiments of the invention, a reduced throughput and an interruption of the throughput may be recognized, and the heating may be switched off prior to any dry running occurring.

As a result, it is possible to arrange the temperature sensor 52 at any optional location along the flow-through path 18 in relation to the heater 33. Thus, the flattened area 44 may be formed at any optional location.

In a preferred embodiment, the temperature sensor 52 is arranged at or near the spatially highest point of the flow-through path 18 with respect to the direction of gravity. The highest point of the flow-through path 18 with respect to the direction of gravity is a particularly critical point since steam or air can accumulate at this point. Such an accumulation of steam or air occurs, for example, when a reduced amount of fluid is flowing through the flow-through path. The transfer of heat is worse in an area in which a bubble of steam or a cushion of air is seated, or in which a two-phase flow is present, than an area with a single-phase fluid flow. The heater may no longer be cooled effectively in such a two-phase flow area, which makes a safety switch-off necessary.

As a result of the detection of reduced throughput or an interruption of the transport of fluid through the flow-through path 18 and the heating then being switched off, the formation of steam or the accumulation of air can be excluded from the beginning, and the positioning of the temperature sensor 52 can thus be planned as required.

In accordance with an embodiment of the invention, a temperature surveillance device 72 is made available which comprises the temperature sensor 52 and the evaluating device 60.

Embodiments of the temperature surveillance device 72 may have a certain intelligence. It may be recognized via this device whether, for example, a reversible stagnation (e.g., an uncritical, reversible case of malfunction) is present. The occurrence of any dry running may be prevented.

It may also be recognized, for example, whether a permanent dry running is present. Thus, additional safety is provided.

This safety is increased further via the thermal melting fuse 66.

While particular embodiments of the present invention have been disclosed, it is to be understood that various different modifications and combinations are possible and are contemplated within the true spirit and scope of the appended claims. There is no intention, therefore, of limitations to the exact abstract and disclosure herein presented.

1. A heating device for a fluid in a basin, comprising:
a flow-through path for a fluid reservoir of the basin;
a heater arranged in the flow-through path, the fluid being able to flow past said heater for the purpose of heating up;
at least one heating element arranged in the heater;
a temperature sensor in thermal communication with said heater, said thermal communication being sufficient for said temperature sensor to determine a temperature of the heater; and
wherein said temperature sensor is adapted to determine absolute temperatures and changes in temperatures based on said thermal communication.

2. The heating device according to claim 1, wherein the temperature sensor is arranged in direct thermal contact with the heater.

3. The heating device according to claim 1, wherein the temperature sensor is arranged on an outer side of a tube forming at least a portion of the flow-through path.

4. The heating device according to claim 1, wherein a tube forming at least a portion of the flow-through path has a contoured, flattened or recessed area, the temperature sensor being arranged on an outer surface of said tube in said area.

5. The heating device according to claim 4, wherein the contoured, flattened or recessed area includes a substantially flat surface.

6. The heating device according to claim 4, wherein the heater is positioned on or near an inner wall of said tube substantially opposing said temperature sensor.

7. The heating device according to claim 6, wherein a gap is located between the heater and the inner wall of the tube in the flattened or recessed area, fluid being able to flow through said gap.

8. The heating device according to claim 1, wherein the at least one heating element is an electrical resistor element having an extension in a longitudinal direction of the heater.

9. The heating device according to claim 8, further comprising at least one thermal melting fuse adapted to interrupt an electrical circuit for the at least one heating element when a predetermined temperature is exceeded.

10. The heating device according to claim 9, wherein the at least one thermal melting fuse is positioned in the vicinity of the temperature sensor.

11. The heating device according to claim 1, further comprising an evaluating device for evaluating signals of the temperature sensor.

12. The heating device according to claim 11, wherein the evaluating device is adapted to recognize whether a reduced volume throughput of fluid through the flow-through path is present based upon signals of the temperature sensor.

13. The heating device according to claim 12, wherein the evaluating device is adapted to recognize whether a reversible case of malfunction or an irreversible case of malfunction is present when a reduced volume throughput is recognized.

14. The heating device according to claim 11, wherein the evaluating device is adapted to recognize whether any dry running of the heater is present based upon signals of the temperature sensor.

15. The heating device according to claim 11, further comprising a circulation pump adapted to be switched off via the evaluating device.

16. The heating device according to claim 15, wherein the circulation pump is adapted to be switched off by the evaluating device when a minimum throughput is not reached.

17. The heating device according to claim 15, wherein at least one of a signal line for controlling the switching off of the circulation pump and an electrical energy supply line is guided through the heater.

18. The heating device according to claim 1, wherein the flow-through path is dimensioned to prevent any dry running of the heater in the case of a throughput of fluid above a minimum throughput.

19. A method for heating a fluid in a basin, wherein the fluid from the basin runs through a heating path located outside a reservoir of the basin comprising:
heating the fluid by a heater with at least one heating element arranged in the heater; and
monitoring the heater via a temperature sensor adapted to determine absolute temperatures at the heater and temporal changes in temperature at the heater.

20. The method according to claim 19, further comprising:
determining, via monitoring of a temperature course in time, whether the fluid throughput through the heating path is below a minimum throughput.

21. The method according to claim 20, further comprising:
switching off a circulation pump when the minimum throughput is not reached.
